(19) United States
(12) Patent Application Publication
(10) Pub. No.: US 2010/0067225 A1
(43) Pub. Date: Mar. 18, 2010

(54) LIGHT EMITTING DIODE LAMP TUBE

(75) Inventors: Chii-Maw Uang, Dashu Township (TW); Huei-Ting Ku, Dashu Township (TW)

Correspondence Address: DARBY & DARBY P.C., P.O. BOX 770, Church Street Station, New York, NY, 10008-0770, US

(73) Assignee: I Shou University, Dashu Township (TW)

(21) Appl. No.: 12/501,233

(22) Filed: Jul. 10, 2009

(30) Foreign Application Priority Data
Sep. 16, 2008 (TW) 097135466

(51) Int. Cl. F21V 1/00; F21S 4/00

(52) U.S. Cl. 362/235; 362/249.02

(57) ABSTRACT

A light emitting diode (LED) lamp tube includes a tubular enclosure extending along an axial direction and having an inner peripheral surface. A lamp device is disposed in the enclosure, and includes a circuit board, and a plurality of LEDs electrically connected to the circuit board. Two connectors are disposed respectively at two ends of the enclosure and are electrically connected to the circuit board. The connectors are adapted to be electrically connected to a power source. An optical film unit is disposed on the inner peripheral surface of the enclosure. The optical film unit has a film body and a plurality of protrusions arranged along the axial direction and protruding from the film body toward the inner peripheral surface of the enclosure.

### CROSS-REFERENCE TO RELATED APPLICATION

This application claims priority of Taiwanese Application No. 097135466, filed on Sep. 16, 2008.

### BACKGROUND OF THE INVENTION

1. Field of the Invention

The invention relates to a light emitting diode (LED) lamp tube, more particularly to a LED lamp tube capable of providing uniform illumination without generating glare.

2. Description of the Related Art

A conventional fluorescent lamp is applied with a fluorescent material on an inner peripheral surface of a tubular enclosure thereof. A small amount of mercury is filled into the lamp to form mercury vapor that generates ultraviolet radiation when the lamp is turned on. Therefore, the fluorescent material is excited by the ultraviolet radiation to emit light. However, once the lamp tube gets broken, the toxic mercury vapor will leak out, thus posing safety concerns. In recent years, for the purpose of environmental consciousness and economizing on power consumption, light emitting diode (LED) lamp tubes have replaced fluorescent tubes.

Referring to FIGS. 1 and 2, in Taiwanese Patent Publication No. M330422, an LED lamp tube 1 for mounting on a lamp seat comprises a tube body 11 having two open ends spaced apart along an axial direction (X), a lamp device 12, and two connectors 13. The tube body 11 has an inner peripheral surface formed with a refracting unit 112 including a plurality of protrusions 113. The protrusions 113 extend along the axial direction (X), and are arranged along a circumferential direction of the tube body 11. Two pairs of circuit board retaining portions 111 are formed on the inner peripheral surface of the tube body 11, and are disposed at the two open ends of the tube body 11, respectively. The lamp device 12 comprises a circuit board 121 and a plurality of LEDs 122. The connectors 13 are disposed for sealing the open ends of the lamp tube 11, and are electrically connected to the circuit board 121. The circuit board retaining portions 111 engage the circuit board 121 of the lamp device 12. Due to the presence of the protrusions 113 of the refracting unit 112, uniformity of illumination can be increased significantly.

Generally speaking, the smaller the dimension of each of the protrusions 113 is, the better will be illumination uniformity of the lamp tube is. However, current molding techniques cannot be used to form the protrusions 113 when they have a height and a width that are smaller than 0.4 mm, thereby limiting the applicable range of the protrusions 113.

### SUMMARY OF THE INVENTION

Therefore, the object of the present invention is to provide a light emitting diode (LED) lamp tube that can provide uniform illumination.

According to the present invention, there is provided an LED lamp tube adapted to be mounted on a lamp seat. The LED lamp tube comprises a tubular enclosure extending along an axial direction, and having two opposite ends and an inner peripheral surface. A lamp device is disposed in the enclosure, and includes a circuit board, and a plurality of LEDs electrically connected to the circuit board. Two connectors are disposed respectively at the ends of the enclosure and are electrically connected to the circuit board. The connectors are adapted to be electrically connected to a power source. An optical film unit is disposed on the inner peripheral surface of the enclosure. The optical film unit has a film body and a plurality of protrusions arranged along the axial direction and protruding from the film body toward the inner peripheral surface of the enclosure.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional light emitting diode (LED) lamp tube;

FIG. 2 is a sectional view of the conventional LED lamp tube, illustrating a plurality of protrusions formed on an inner peripheral surface of a tube body of the LED lamp tube;

FIG. 3 is an exploded perspective view of an LED lamp tube of a first preferred embodiment according to the present invention;

FIG. 4 is a sectional view of the first preferred embodiment of the present invention;

FIG. 5 is a fragmentary enlarged view of FIG. 4 of the first preferred embodiment; and

FIG. 6 is a fragmentary enlarged view of a LED lamp tube of a second preferred embodiment according to the present invention.

### DETAILED DESCRIPTION OF THE PREFERRED EMBODIMENTS

Before the present invention is described in greater detail, it should be noted that like elements are denoted by the same reference numerals throughout the disclosure.

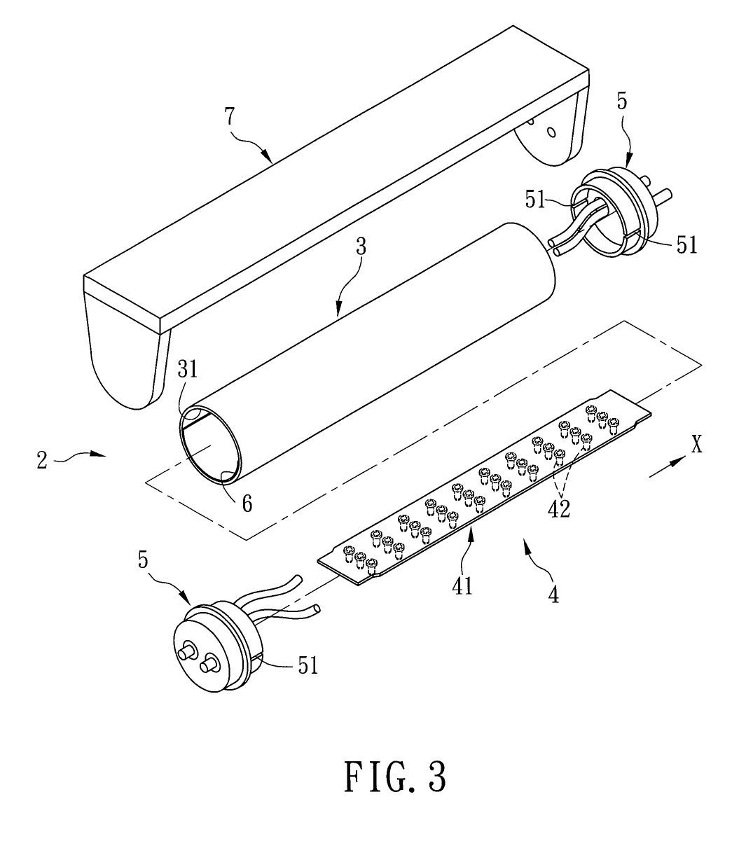

Referring to FIG. 3, a light emitting diode (LED) lamp tube 2 of a first preferred embodiment of the present invention is adapted to be mounted on a lamp seat 7. The LED lamp tube 2 comprises a tubular enclosure 3, a lamp device 4, two connectors 5, and an optical film unit 6. The tubular enclosure 3 extends along an axial direction (X), and has two opposite ends and an inner peripheral surface 31.

The lamp device 4 is disposed in the enclosure 3. The lamp device 4 includes a circuit board 41, and a plurality of LEDs 42 electrically connected to the circuit board 41. The connectors 5 are disposed respectively at the ends of the enclosure 3, are adapted to be electrically connected to a power source (not shown), and are electrically connected to the circuit board 41. Each of the connectors 5 includes two circuit board retaining slots 51 engaging the corresponding end of the circuit board 41.

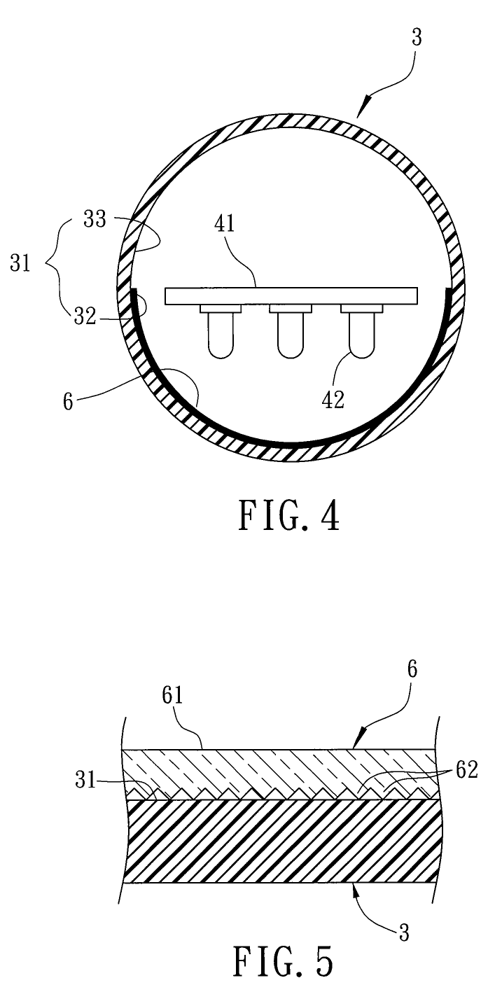

As further shown in FIGS. 4 and 5, the optical film unit 6 is disposed on (e.g., adhered to) the inner peripheral surface 31 of the enclosure 3. The optical film unit 6 includes a film body in the form of a light diffuser film 61, and a plurality of protrusions 62. The protrusions 62 are shaped as isosceles triangles in cross-section, are arranged along the axial direction (X), protrude from the film body (i.e., the light diffuser film 61) toward the inner peripheral surface 31 of the enclosure 3, and are formed on the light diffuser film 61.

The circuit board 41 is disposed in the enclosure 3 such that the inner peripheral surface 31 is divided into a light-receiving portion 32 for receiving light emitted by the LEDs 42 and a non-illuminated portion 33. The optical film unit 6 is disposed on the light-receiving portion 32 of the inner peripheral surface 31.

Light emitted by the LEDs 42 is transmitted into and diffused in the light diffuser film 61. Subsequently, light diffused by the diffuser film 61 is further transmitted into and refracted by the protrusions 62 formed on the diffuser film 61. Hence, uniform illumination is achieved, and glare is prevented.

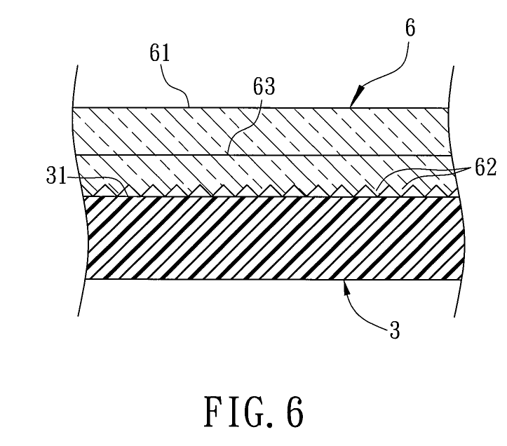

As shown in FIG. 6, a second preferred embodiment of the LED lamp tube 2 according to the present invention has a structure similar to that of the first embodiment. The main difference between this embodiment and the first embodiment resides in the following. The film body of the optical film unit 6 includes a light diffuser film 61 and a brightness enhancement film 63 disposed between the light diffuser film 61 and the inner peripheral surface 31 of the enclosure 3. The protrusions 62 are shaped as isosceles triangles in cross-section, protrude from the film body toward the inner peripheral surface 31 of the enclosure 3, and are formed on the brightness enhancement film 63. The second preferred embodiment has the same advantages as those of the first preferred embodiment.

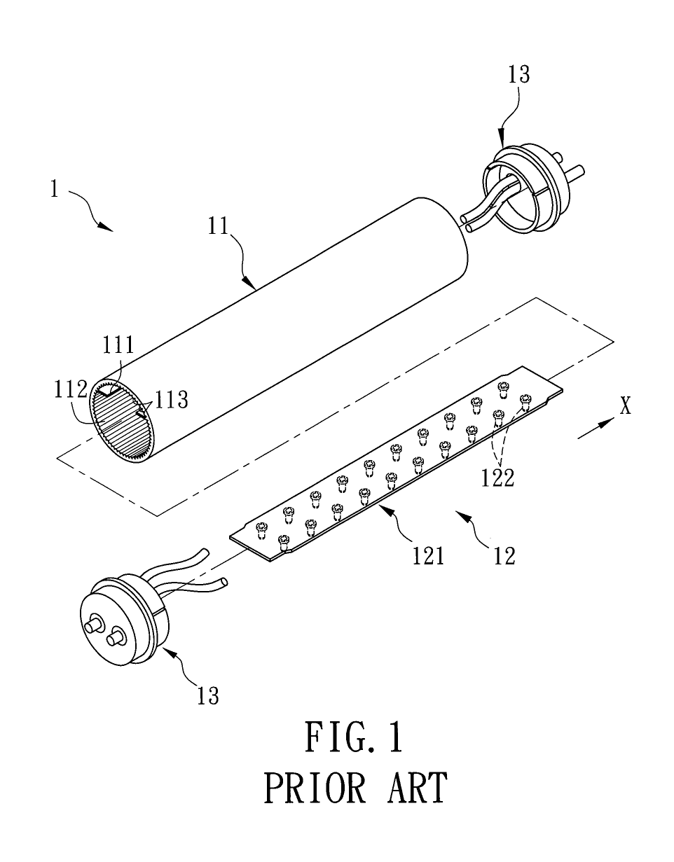

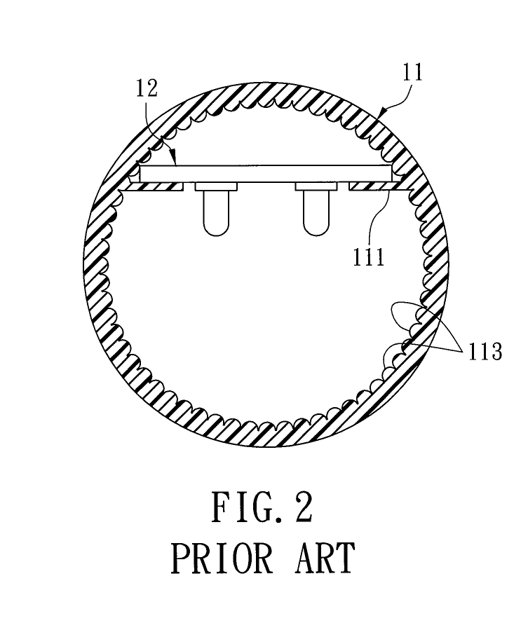

To sum up, the advantages of the LED lamp tube 2 according to the present invention are as outlined in the following. Referring back to FIG. 1, since the protrusions 113 are formed integrally with the inner peripheral surface 111 of the lamp tube 11 of the conventional LED lamp tube, precision instruments and a complicated process are required for forming the lamp tube 11. Referring to FIGS. 4 to 6, in the present invention, the protrusions 62 are formed on the optical film unit 6, thus eliminating the requirement of the precision instruments and the complicated manufacturing process. As a result, the height and the width of the protrusions 62 can be suitably designed. Furthermore, uniform illumination is provided without glare by use of the optical film unit 6.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A light emitting diode (LED) lamp tube adapted to be mounted on a lamp seat, said LED lamp tube comprising:
a tubular enclosure extending along an axial direction and having two opposite ends and an inner peripheral surface;
a lamp device disposed in said enclosure, said lamp device including a circuit board, and a plurality of LEDs electrically connected to said circuit board;
two connectors disposed respectively at said ends of said enclosure and electrically connected to said circuit board, said connectors being adapted to be electrically connected to a power source; and
an optical film unit disposed on said inner peripheral surface of said enclosure, said optical film unit having a film body and a plurality of protrusions arranged along the axial direction and protruding from said film body toward said inner peripheral surface of said enclosure.

2. The LED lamp tube as claimed in claim 1, wherein said optical film unit includes a light diffuser film, said protrusions being formed on said light diffuser film.

3. The LED lamp tube as claimed in claim 2, wherein said inner peripheral surface of said enclosure has a light-receiving portion for receiving light emitted by said LEDs, said optical film unit being disposed on said light-receiving portion.

4. The LED lamp tube as claimed in claim 3, wherein said protrusions are shaped as isosceles triangles in cross-section.

5. The LED lamp tube as claimed in claim 1, wherein said optical film unit includes a light diffuser film and a brightness enhancement film disposed between said light diffuser film and said inner peripheral surface of said enclosure, said protrusions being formed on said brightness enhancement film.

6. The LED lamp tube as claimed in claim 5, wherein said inner peripheral surface of said enclosure has a light-receiving portion for receiving light emitted by said LEDs, said optical film unit being disposed on said light-receiving portion

7. The LED lamp tube as claimed in claim 6, wherein said protrusions are shaped as isosceles triangles in cross-section.
